(19) United States
(12) Patent Application Publication
(10) Pub. No.: US 2007/0231625 A1
(43) Pub. Date: Oct. 4, 2007

(54) Fuel Cell System

(75) Inventor: Masayoshi Okumi, Aichi (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Aichi-ken (JP)

(21) Appl. No.: 11/547,025

(22) PCT Filed: May 12, 2005
(86) PCT No.: PCT/JP05/09111

§ 371 Date: Oct. 2, 2006

(30) Foreign Application Priority Data
May 14, 2004 (JP) 2004-145501

(51) Int. Cl. H01M 8/04

(52) U.S. Cl. 429/13; 429/22

(57) ABSTRACT

The present invention relates to a fuel cell system in which a high-pressure gas supply tube is connected to a gas supply opening of a fuel cell, a gas pressure regulating valve is installed in the middle of the high-pressure gas supply tube, and upstream-side and downstream-side shut-off valves are provided respectively on the upstream side and the downstream side of the gas pressure regulating valve in the high-pressure gas supply tube. The fuel cell system is activated by opening the upstream-side shut-off valve and thereafter opening the downstream-side shut-off valve. In the fuel cell system, there has been a problem that when the upstream-side shut-off valve is opened and thereafter the downstream-side shut-off valve is opened in a state in which the upstream side of the downstream-side shut-off valve on the hydrogen supply tube is not sufficiently pressurized, high-pressure gas which passes through a throttle section of the hydrogen pressure regulating valve causes pulsation in the supply tube, producing a loud noise.

The present invention is to solve the above problem by providing, in the fuel cell system, control means for delaying the timing for opening the downstream-side shut-off valve (33) by a predetermined time period with respect to the timing for opening the upstream-side shut-off valve (31) when the pressure difference between gas pressure (P3) on the upstream side of the upstream-side shut-off valve (31) and gas pressure (P1) on the downstream side of the downstream-side shut-off valve (33) is greater than a reference value.

### BACKGROUND

The present invention relates to a fuel cell system.

A fuel cell system comprises a fuel cell in which a plurality of unit cells, each of which has an electrolyte between the anode electrode and the cathode electrode, are laminated, as described in Japanese Patent Application Laid-Open No. 2002-373687. The hydrogen (fuel gas), which is supplied by a hydrogen supply tube connected to a hydrogen supply opening of the fuel cell, is brought into contact with the anode electrode, and the air (oxide gas), which is supplied by an air supply tube connected to an air supply opening of the fuel cell, is brought into contact with the cathode electrode, whereby an electrochemical reaction is generated, and the fuel cell generates electricity by means of the electrochemical reaction.

The fuel cell system described in Japanese Patent Application Laid-Open No. 2002-373687 discloses that a vibration control member is provided in a tube in which gas to be pumped into the fuel cell is conveyed while pulsating, for conveying the gas, whereby noise caused by a vibration of the tube can be prevented from occurring.

In a conventional fuel cell system, a high-pressure hydrogen supply tube is connected to the hydrogen supply opening of the fuel cell, a hydrogen pressure regulating valve is installed in the middle of the hydrogen supply tube, and upstream-side and downstream-side shut-off valves are provided respectively on the upstream side and the downstream side of the hydrogen pressure regulating valve of the hydrogen supply tube.

Such a fuel cell system is activated by, as shown in FIG. 7, opening the upstream-side shut-off valve and subsequently opening the downstream-side shut-off valve. However, when the downstream-side shut-off valve is opened before the upstream side of the downstream-side shut-off valve on the hydrogen supply tube is not sufficiently pressurized, high-pressure gas which passes through a throttle section of the hydrogen pressure regulating valve (orifice, flow amount controller, flowmeter, or the like) causes pulsation in the supply tube. At this moment, pulsation of gas pressure P1 on the downstream side of the downstream-side shut-off valve inside the fuel cell and pulsation of primary gas pressure P2 of the hydrogen pressure regulating valve are generated. These pulsations produce a large vibration and a loud noise in the hydrogen supply tube.

It should be noted that even if the vibration control member described in Japanese Patent Application Laid-Open No. 2002-373687 is provided in the abovementioned hydrogen supply tube, only a vibration of a specific frequency region is absorbed.

### SUMMARY

An object of the present invention is to prevent the occurrence of a vibration noise in a high-pressure gas supply tube in a widespread piping and a component resonance frequency.

In order to solve the above problem, a fuel cell system of the present invention is a fuel cell system in which a high-pressure gas supply tube is connected to a gas supply opening of a fuel cell, a gas pressure regulating valve is installed in the middle of the high-pressure gas supply tube, and upstream-side and downstream-side shut-off valves are provided respectively on the upstream side and the downstream side of the gas pressure regulating valve in the high-pressure gas supply tube. The fuel cell system includes control means for delaying the timing for opening the downstream-side shut-off valve by a predetermined time period with respect to the timing for opening the upstream-side shut-off valve when the pressure difference between gas pressure on the upstream side of the upstream-side shut-off valve and gas pressure on the downstream side of the downstream-side shut-off valve is greater than a reference value. It should be noted that “gas pressure regulating valve” is not limited to a regulator. An orifice, a flow amount controller, a flowmeter and the like are equivalent to “gas pressure regulating valve” as long as they have a “throttle section” which controls flow of the gas inside the supply tube.

(a) According to the configuration of the present invention, by producing a predetermined time delay to open the downstream-side shut-off valve after opening the upstream-side shut-off valve, the downstream-side shut-off valve is opened in a state in which the upstream side of the downstream-side shut-off valve on the high-pressure gas supply tube is sufficiently pressurized. Accordingly, it is possible to prevent the occurrence of pulsation (occurrence of vibration/noise when supplying gas) in the supply tube, the pulsation being caused by high-pressure gas passing through a throttle section of the gas pressure regulating valve (orifice, flow amount controller, flowmeter, or the like). Since the present invention is to prevent the occurrence of a pulsation of gas pressure in the high-pressure gas supply tube, the occurrence of a vibration noise in the high-pressure gas supply tube can be prevented in a widespread piping and a component resonance frequency.

Here, the high-pressure gas supply tube may be a fuel gas (anode gas) supply tube or an oxide gas (cathode gas) supply tube.

According to a preferred aspect of the present invention, a high-pressure gas source is connected to the upstream side of the upstream-side shut-off valve.

Here, the high-pressure gas source is same as a gas tank, a pump or the like. For example, when the high-pressure gas supply tube is a supply tube for fuel gas, a gas tank in which hydrogen or CNG (Compressed Natural Gas) reformed to hydrogen is stored corresponds to the high-pressure gas source. If the high-pressure gas supply tube is a supply tube for oxide gas, a pump (compressor) which receives oxide gas such as ambient air corresponds to the high-pressure gas source.

According to a preferred aspect of the present invention, when the pressure difference between gas pressure on the upstream side of the upstream-side shut-off valve and gas pressure on the downstream side of the downstream-side shut-off valve is greater than a reference value, when the gas pressure on the downstream side of the downstream-side shut-off valve is smaller than an in-fuel-cell threshold value, which is determined with respect to residual gas pressure in the fuel cell, and when the gas pressure between the upstream-side shut-off valve and the downstream-side shut-off valve is smaller than an in-tube threshold value, which is determined with respect to residual gas pressure in the high-pressure gas supply tube, the control means delays the timing for opening the downstream-side shut-off valve by a predetermined time period with respect to the timing for opening the upstream-side shut-off valve.

According to the above configuration, when the gas pressure (P1) on the downstream side of the downstream-side shut-off valve is smaller than an in-fuel-cell threshold value (Pa), which is determined with respect to residual gas pressure in the fuel cell, and when the gas pressure (P2) between the upstream-side shut-off valve and the downstream-side shut-off valve is smaller than an in-tube threshold value (Pb), which is determined with respect to residual gas pressure in the high-pressure gas supply tube, it means that constant gas pressure does not remain in each of the fuel cell and high-pressure gas supply tube. At this moment, in the above description (a), by opening the upstream-side shut-off valve and thereafter opening the downstream-side shut-off valve after a delay of a predetermined time period (a fixed time interval), the high-pressure gas passes through the high-pressure gas supply tube from the upstream to the downstream at once at speed close to that of sound, whereby the occurrence of vibration at the gas pressure regulating valve, orifice or curved section in the tube, and the like can be avoided.

In this case, preferably, the gas pressure between the upstream-side shut-off valve and the downstream-side shut-off valve is primary side pressure of the gas pressure regulating valve.

According to a preferred aspect of the present invention, the higher the gas pressure on the downstream side of the downstream-side shut-off valve is, the shorter the predetermined time period set by the control means is; and the higher the gas pressure between the upstream-side shut-off valve and the downstream-side shut-off valve is, the shorter the predetermined time period set by the control means is.

According to the above configuration, the higher the gas pressure (P1) on the downstream side of the downstream-side shut-off valve is, the shorter the predetermined time period (time interval) is set, and the higher the gas pressure (P2) between the upstream-side shut-off valve and the downstream-side shut-off valve is, the shorter the predetermined time period (time interval) is set, whereby the downstream-side shut-off valve can be opened effectively in a state in which the upstream side of the downstream-side shut-off valve on the high-pressure gas supply tube is sufficiently pressurized.

According to a preferred aspect of the present invention, the smaller the pressure difference between the gas pressure on the upstream side of the upstream-side shut-off valve and the gas pressure on the downstream side of the downstream-side shut-off valve is, the shorter the predetermined time period set by the control means is.

According to a preferred aspect of the present invention, the predetermined time period is a time period since the upstream-side shut-off valve is opened until the gas pressure between the upstream-side shut-off valve and the downstream-side shut-off valve becomes higher than the in-tube threshold value, which is determined with respect to the residual gas pressure in the high-pressure gas supply tube.

According to a preferred aspect of the present invention, when the pressure difference between the gas pressure on the upstream side of the upstream-side shut-off valve and the gas pressure on the downstream side of the downstream-side shut-off valve is smaller than the reference value, the control means matches the timing for opening the upstream-side shut-off valve with the timing for opening the downstream-side shut-off valve.

According to a preferred aspect of the present invention, the fuel cell system further comprises a first pressure sensor which detects gas pressure on the upstream side of the upstream-side shut-off valve, and a second pressure sensor which detects gas pressure on the downstream side of the downstream-side shut-off valve. The control means detects the pressure difference based on the first pressure sensor and the second pressure sensor.

According to a preferred aspect of the present invention, fuel gas flows in the high-pressure gas supply tube.

A control method for shut-off valves in the fuel cell system of the present invention is a control method for shut-off valves in the fuel cell system in which a high-pressure gas supply tube is connected to a gas supply opening of a fuel cell, a gas pressure regulating valve is installed in the middle of the high-pressure gas supply tube, and upstream-side and downstream-side shut-off valves are provided respectively on the upstream side and the downstream side of the gas pressure regulating valve in the high-pressure gas supply tube. The control method includes the step of delaying the timing for opening the downstream-side shut-off valve by a predetermined time period with respect to the timing for opening the upstream-side shut-off valve when the pressure difference between gas pressure on the upstream side of the upstream-side shut-off valve and gas pressure on the downstream side of the downstream-side shut-off valve is greater than a reference value.

### DESCRIPTION OF THE DRAWINGS

FIG. 1 is a system diagram of the piping showing the fuel cell system;

FIG. 2 is an enlarge view showing a substantial part of FIG. 1;

FIGS. 3A and 3B are schematic diagrams showing a control map of the fuel cell system;

FIG. 4 is a flow chart showing an example of a control procedure in the fuel cell system;

FIG. 5 is a diagram of pressure showing a control state in the fuel cell system;

FIG. 6 is a flow chart showing another example of the control procedure in the fuel cell system; and

FIG. 7 is a diagram of pressure showing a control state in a conventional fuel cell system.

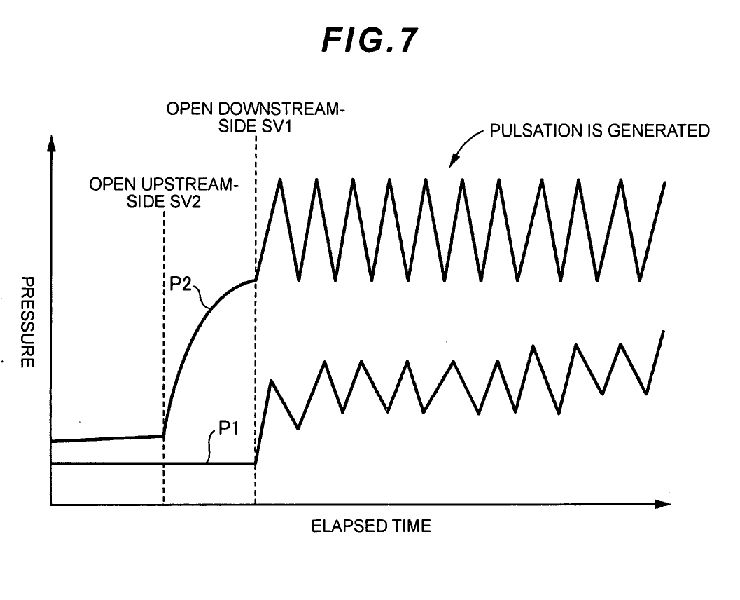

### DETAILED DESCRIPTION

A fuel cell system 10 comprises a fuel cell 11 in which a plurality of unit cells, each of which has an electrolyte between an anode electrode and a cathode electrode, are laminated. Hydrogen (fuel gas), which is supplied by a hydrogen supply tube 75 connected to a hydrogen supply opening of the fuel cell 11, is brought into contact with the anode electrode, and the air (oxide gas), which is supplied by an air supply tube 71 connected to an air supply opening of the fuel cell 11, is brought into contact with the cathode electrode, whereby an electrochemical reaction is generated, and the fuel cell 11 generates electricity by means of the electrochemical reaction.

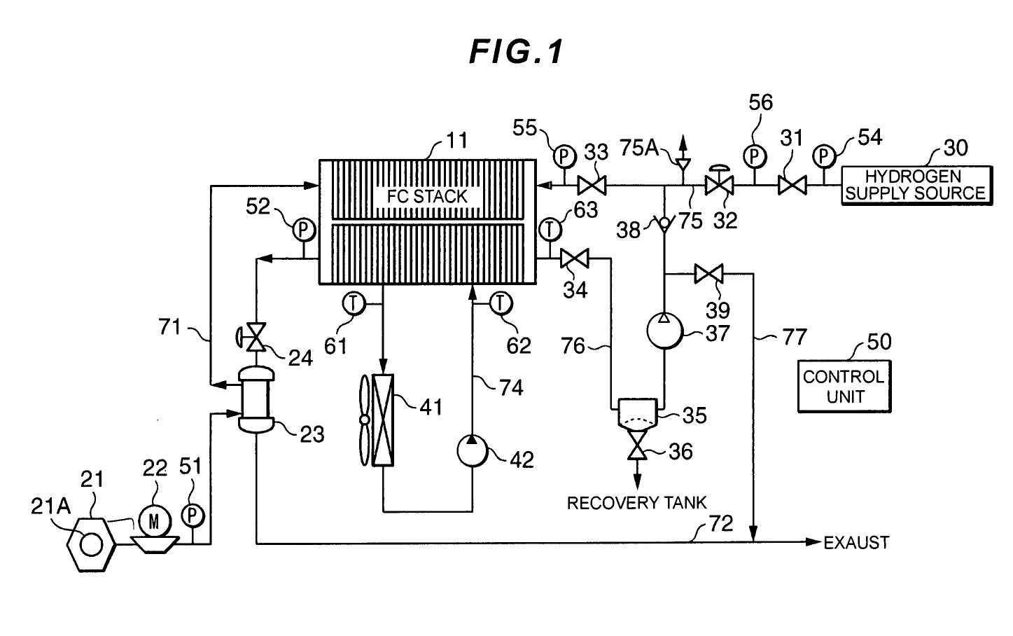

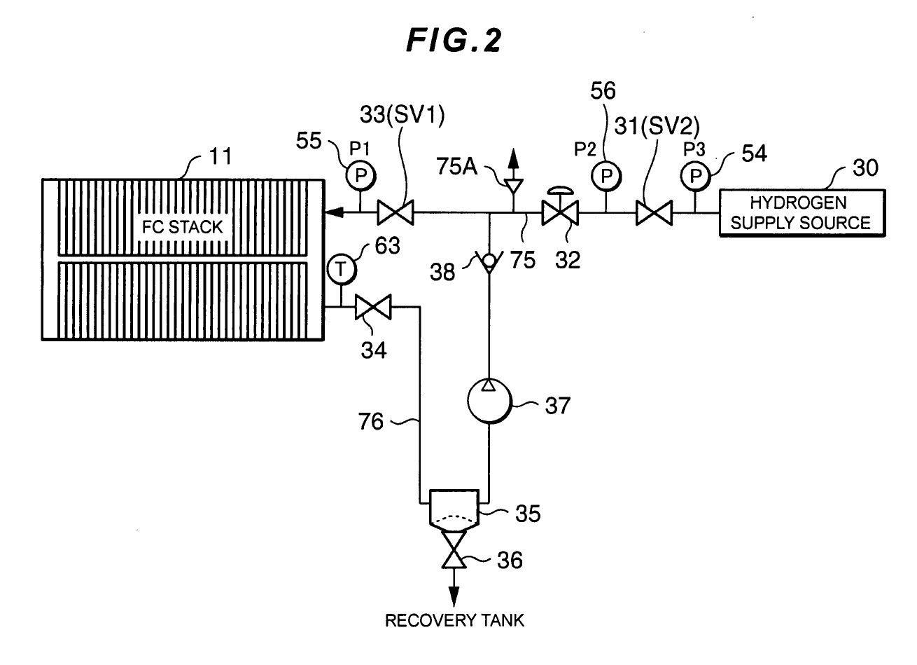

Specifically, as shown in FIGS. 1 and 2, in the fuel cell system 10 the air (ambient air) is supplied as oxide gas to the air supply opening of the fuel cell 11 via the air supply tube 71. The air supply tube 71 is provided with an air filter 21 which removes fine particles from air, a compressor 22 which pressurizes air, a pressure sensor 51 which detects the pressure of supplied air, and a humidifier 25 which adds required moisture to air. It should be noted that the air filter 21 is provided with an air flow meter (flowmeter) 21A which detects the amount of air flow.

Air off-gas which is discharged from the fuel cell 11 is discharged to the outside through a discharge path 72. The discharge path 72 is provided with pressure sensor 52 which detects discharge pressure, a pressure regulating valve 24, and a heat exchanger of a humidifier 23. The pressure regulating valve (pressure-reducing valve) 24 functions as a pressure controller for setting the pressure of air supplied to the fuel cell 11 (air pressure). Detection signal (not shown) of the pressure sensors 51 and 52 are sent to a control unit 50 (control means). The control unit 50 regulates the compressor 22 and the pressure regulating valve 24 and thereby sets the pressure of supplied air and the supply flow amount.

Hydrogen, which is fuel gas, is supplied from a hydrogen supply source 30 (high-pressure gas source) to the hydrogen supply opening of the fuel cell 11 via the hydrogen supply tube 75 (high-pressure gas supply tube). The hydrogen supply tube 75 is provided with a pressure sensor 54 which detects the pressure of the hydrogen supply source, an upstream-side shut-off valve (SV 2) 31, a hydrogen pressure regulating valve 32 which regulates the pressure of hydrogen supplied to the fuel cell 11, a relief valve 75A which is released when abnormal pressure is generated in the hydrogen supply tube 75, a downstream-side shut-off valve (SV 1) 33, and a pressure sensor 55 which detects inlet pressure of hydrogen gas. A pressure sensor 56, which detects the pressure of hydrogen gas in the tube, is provided at an intermediate section between the upstream-side shut-off valve 31 and the downstream-side shut-off valve 33 in the hydrogen supply tube 75 and, in the present embodiment, at an intermediate section between the upstream-side shut-off valve 31 and the hydrogen pressure regulating valve 32. Detections signals (not shown) of the pressure sensors 54, 55 and 56 are sent to the control unit 50.

Hydrogen which is not consumed in the fuel cell 11 is discharged as hydrogen off-gas to a hydrogen circulation passage 76 and returned to the downstream-side shut-off valve in the hydrogen supply tube 75. The hydrogen circulation passage 76 is provided with a temperature sensor 63 which detects the temperature of hydrogen off-gas, a shut-off valve 34 which discharges hydrogen off-gas, a gas-liquid separator 35 which recovers moisture from the hydrogen-off gas, a drain valve 36 which recovers the recovered moisture to an unshown tank, a hydrogen pump 37 which pressurizes hydrogen off-gas, and a check valve 38. The shut-off valves 33 and 34 correspond to closing means for closing the anode side of the fuel cell. The detection signal (not shown) of the temperature sensor 63 is sent to the control unit 50. Operation of the hydrogen pump 37 is controlled by the control unit 50. Hydrogen off-gas joins hydrogen gas at the hydrogen supply tube 75 and supplied and reused in the fuel cell 11. The check valve 40 prevents hydrogen gas of the hydrogen supply tube 75 from flowing backward toward the hydrogen circulation passage 76.

The hydrogen circulation passage 76 is connected to the discharge path 72 by a purge passage 77 via a purge valve 39. The purge valve 39 is an electromagnetic shut-off valve and activated by a command from the control unit 50 to discharge (purge) hydrogen off-gas to the outside. By performing this purging operation intermittently, decrease of the cell voltage, which is caused by a repeat of circulation of hydrogen off-gas and an increase in the impurity concentration of hydrogen gas on the fuel electrode side, can be prevented.

Furthermore, a cooling water port opening of the fuel cell 11 is provided with a cooling path 74 which circulates cooling water. The cooling path 74 is provided with a temperature sensor 61 which detects the temperature of cooling water discharged from the fuel cell 11, a radiator (heat exchanger) 41 which discharges the heat of cooling water to the outside, a pump 42 which pressurizes and circulates cooling water, and a temperature sensor 62 which detects the temperature of cooling water supplied to the fuel cell 11.

The control unit 50 receives a request load such as an acceleration signal of a vehicle which is not shown, or control information from each sensor of the fuel cell system, and controls operations of various valves and motors. The control unit 50 is configured with a control computer system which is not shown. The control computer system can be configured with a known available system.

Therefore, the fuel cell system 10 prevents the occurrence of a vibration noise which is caused by pulsation of the hydrogen gas pressure in the hydrogen supply tube 75 functioning as a high-pressure gas supply tube, and thus includes the following configurations.

In the fuel cell system 10, as described above, the hydrogen pressure regulating valve 32 is installed in the middle of the hydrogen pressure tube 75, and the upstream-side shut-off valve 31 and the downstream-side shut-off valve 33 are provided respectively at the upstream side and the downstream side of the hydrogen pressure regulating valve 32 in the hydrogen supply tube 75. In the fuel cell system 10, the pressure sensor 55 detects the gas pressure P1 on the downstream side (including the fuel cell 11) of the downstream-side shut-off valve 33, and the pressure sensor 54 detects the gas pressure P3 on the upstream side of the upstream-side shut-off valve 31. Moreover, in the fuel cell system 10, the pressure sensor 56 detects the gas pressure P2 at the intermediate section between the upstream-side shut-off valve 31 and the downstream-side shut-off valve 33, the intermediate section being, in the present embodiment, the intermediate section between the upstream-side shut-off valve 31 and the hydrogen pressure regulating valve 32 (primary side in the hydrogen regulating valve 32).

The control unit 50 performs interval control under a first condition that the pressure difference (P3−P1) between the gas pressure P3 on the upstream side of the upstream-side shut-off valve 31 and the gas pressure P1 on the downstream side of the downstream-side shut-off valve 33 is larger than a predefined reference value Plimit.

The control unit 50 performs interval control under a second condition that the gas pressure P1 on the downstream side of the downstream-side shut-off valve 33 is smaller than an in-fuel-cell threshold value Pa which is determined beforehand with respect to the residual gas pressure in the fuel cell 11, and that the gas pressure P2 (primary pressure of the hydrogen pressure regulating valve 32 in the present embodiment) between the upstream-side shut-off valve 31 and the downstream-side shut-off valve 33 is smaller than a in-tube threshold value Pb which is determined beforehand with respect to the residual gas pressure in the hydrogen supply tube 75.

Under the first and second conditions (however, only the first condition may be used), the control unit 50 performs interval control for delaying the timing for opening the downstream-side shut-off valve 33 by a fixed time interval (predetermined time period) T with respect to the timing for opening the upstream-side shut-off valve 31.

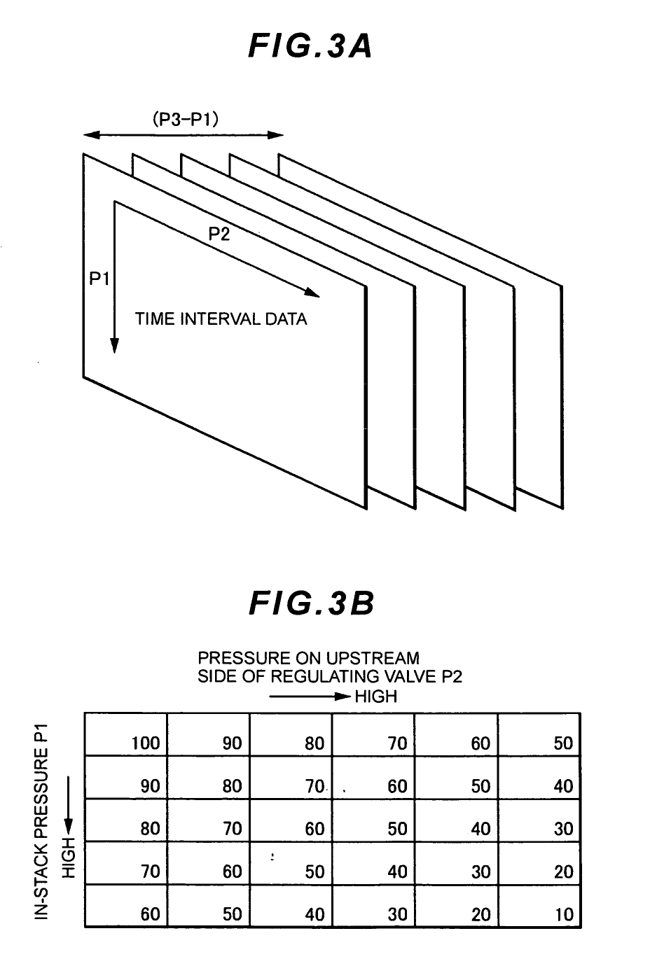

As shown in FIG. 3A, the control unit 50 has a third-dimensional map for determining the time interval T by means of P1 and P2, for the abovementioned each (P3−P1) parameter. The smaller the (P3−P1) is, the shorter the time interval T (mSec) is set. FIG. 3B shows data of the time interval T (mSec) determined by P1 and P2 in a certain (P3−P1) parameter. The larger the gas pressure P1 on the downstream side of the downstream-side shut-off valve 33 is, the shorter the time interval T is set, and the larger the gas pressure P2 (primary pressure of the hydrogen pressure regulating valve 32 in the present embodiment) between the upstream-side shut-off valve 31 and the downstream-side shut-off valve 33 is, the shorter the time interval T is determined.

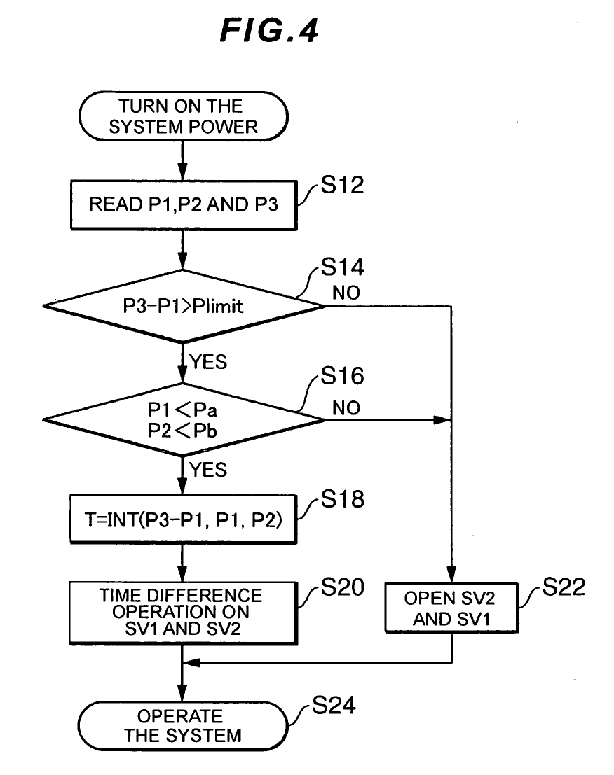

Therefore, in the fuel cell system 10, the procedure of the interval control performed by the control unit 50 is as follows (FIG. 4).

(1) The gas pressure P1 on the downstream side of the downstream-side shut-off valve 33 (SV 1) is detected by the pressure sensor 55, the gas pressure P3 on the upstream side of the upstream-side shut-off valve 31 (SV 2) is detected by the pressure sensor 54, and the gas pressure P2 (the primary pressure of the hydrogen pressure regulating valve 32 in the present embodiment) between the upstream-side shut-off valve 31 and the downstream-side shut-off valve 33 is detected by the pressure sensor 56 (S12).

(2) The first condition of the interval control is judged. If (P3−P1) is smaller than the reference value Plimit, the first condition is not established. Thus the upstream-side shut-off valve 31 and the downstream-side shut-off valve 33 is opened to start the operation of the fuel cell 11 (S22). Here, the reference value Plimit is determined in an experiment or simulation beforehand, as a pressure value having a magnitude so that pulsation/vibration is not caused under the conditions of the gas supply tube, gas pressure regulating, and gas pressure to be used (S14).

(3) If (P3−P1) is larger than the reference value Plimit, the first condition of the interval control is established, thus subsequently the second condition is judged. If P1≧Pa and/or P2≧Pb, the second condition is not established, thus the upstream-side shut-off valve 31 and the downstream-side shut-off valve 33 are opened to start the operation of the fuel cell 11. Here, each of the threshold values Pa and Pb is determined in an experiment or simulation beforehand, as a pressure value having a magnitude so that pulsation/vibration is not caused under the conditions of the gas supply tube, gas pressure regulating, and gas pressure (S16).

(4) If P1<Pa and P2<Pb, the second condition of the interval control is established, thus P1 and P2 are applied to the abovementioned three-dimensional map (P3−P1) to set the time interval (predetermined time period) T (S18).

(5) A time difference operation for opening the upstream-side shut-off valve 31 and subsequently opening the downstream-side shut-off valve 33 after the time interval T is conducted, and thereby the operation of the fuel cell 11 starts (S20).

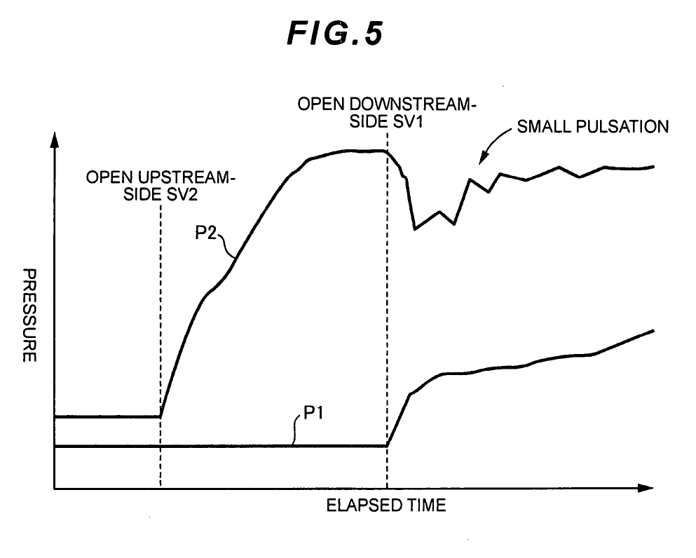

Therefore, according to the present embodiment, the following effects are achieved (FIG. 5).

(a) After the upstream-side shut-off valve 31 is opened, time is delayed by the fixed time interval T to open the downstream-side shut-off valve 33, whereby the downstream-side shut-off valve 33 is opened in a state in which the upstream side of the downstream-side shut-off valve 33 on the hydrogen supply tube 75 is sufficiently pressurized, as shown in FIG. 5. Accordingly, frequent opening and closing of the hydrogen regulating valve 32 (orifice, flow amount controller) is not performed and, as a result, pulsation of the in-fuel-cell gas pressure P1 on the downstream side of the downstream-side shut-off valve 33 and pulsation of the primary gas pressure P2 of the hydrogen regulating valve 32 are not generated, thus a large vibration and noise is not generated in the hydrogen supply tube 75. Since pulsation of the gas pressure is not generated in the hydrogen supply tube 75, the occurrence of a vibration noise in the hydrogen supply tube 75 can be prevented in a widespread piping and a component resonance frequency.

(b) When the gas pressure P1 on the downstream side of the downstream-side shut-off valve 33 is smaller than the in-fuel-cell threshold value Pa which is determined with respect to the residual gas pressure in the fuel cell 11, and when the gas pressure P2 between the upstream-side shut-off valve 31 and the downstream-side shut-off valve 33 is smaller than the in-tube threshold value Pb which is determined with respect to the residual gas pressure in the hydrogen supply tube 75, it means that constant gas pressure does not remain in each of the fuel cell 11 and hydrogen supply tube 75. At this moment, in the above description (a), by opening the upstream-side shut-off valve 31 and thereafter opening the downstream-side shut-off valve 33 after a delay of the fixed time interval T, high-pressure gas passes through the hydrogen supply tube 75 from the upstream to the downstream at once at speed close to that of sound, whereby the occurrence of vibration at the hydrogen pressure regulating valve 32, orifice or curved section in the tube, and the like can be avoided.

(c) The larger the gas pressure P1 on the downstream side of the downstream-side shut-off valve 33 is, the shorter the time interval T is set, and the larger the gas pressure P2 between the upstream-side shut-off valve 31 and the downstream-side shut-off valve 33 is, the shorter the time interval T is set, whereby the downstream-side shut-off valve 33 can be opened effectively in a state in which the upstream side of the downstream-side shut-off valve 33 on the hydrogen supply tube 75 is sufficiently pressurized.

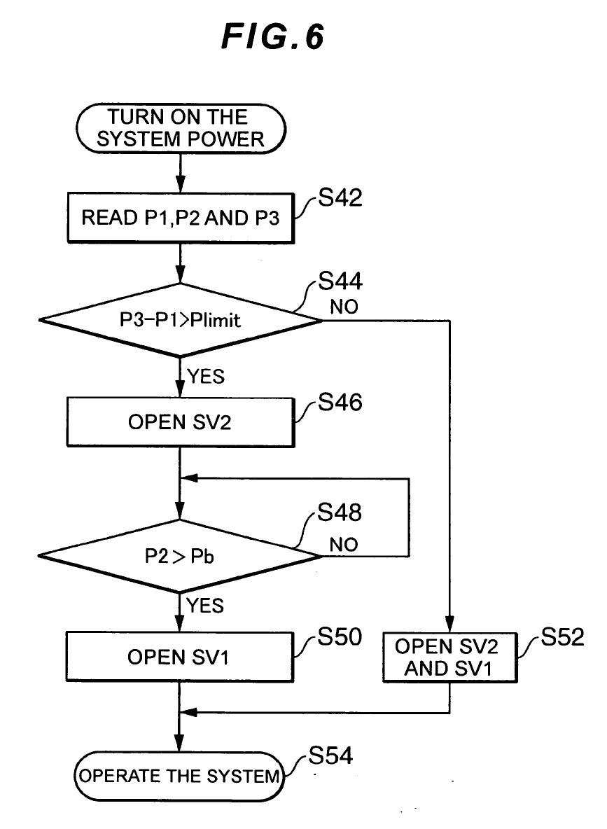

The interval control operation of the control unit 50 in the fuel cell system 10 may be performed according to the following procedure as shown in FIG. 6.

(1) The gas pressure P1 on the downstream side of the downstream-side shut-off valve 33 (SV 1) is detected by the pressure sensor 55, the gas pressure P3 on the upstream side of the upstream-side shut-off valve 31 (SV 2) is detected by the pressure sensor 54, and the gas pressure P2 (the primary pressure of the hydrogen pressure regulating valve 32 in the present embodiment) between the upstream-side shut-off valve 31 and the downstream-side shut-off valve 33 is detected by the pressure sensor 56 (S42).

(2) The first condition of the interval control is judged (S44). If (P3−P1) is smaller than the reference value Plimit, the first condition is not established. Thus the upstream-side shut-off valve 31 and the downstream-side shut-off valve 33 are opened (S52) to start the operation of the fuel cell 11 (S54).

(3) If (P3−P1) is larger than the reference value Plimit, the first condition is established, thus only the upstream-side shut-off valve 31 is opened (S46).

(4) Opening of the downstream-side shut-off valve 33 is delayed and waited for the fixed time interval (predetermined time period) between after the upstream-side shut-off valve 31 is opened and when the gas pressure P2 (the primary pressure of the hydrogen pressure regulating valve 32 in the present embodiment) between the upstream-side shut-off valve 31 and the downstream-side shut-off valve 33 becomes higher than the in-tube threshold valve Pb (P2>Pb) which is determined beforehand with respect to the residual gas pressure in the hydrogen supply tube 75 (S48).

(5) When P2>Pb, the downstream-side shut-off valve 33 is opened (S50) and the operation of the fuel cell 11 is started (S54).

In the case of the interval control operation shown in FIG. 6, by opening the upstream-side shut-off valve 31 and thereafter opening the downstream-side shut-off valve 33 after a delay of the fixed time interval (predetermined time period) T, the downstream-side shut-off valve 33 is opened in a state in which the upstream side of the downstream-side shut-off valve 33 on the hydrogen supply tube 75 is sufficiently pressurized. Accordingly, frequent opening and closing of the hydrogen regulating valve 32 (orifice, flow amount controller) is not performed and, as a result, pulsation of the in-fuel-cell gas pressure P1 on the downstream side of the downstream-side shut-off valve 33 and pulsation of the primary gas pressure P2 of the hydrogen regulating valve 32 are not generated, thus a large vibration and noise is not generated in the hydrogen supply tube 75. Since pulsation of the gas pressure is not generated in the hydrogen supply tube 75, the occurrence of a vibration noise in the hydrogen supply tube 75 can be prevented in a widespread piping and a component resonance frequency.

It should be noted that the above has described an example of the hydrogen supply tube 75, which is a tube of anode gas type, as “high-pressure gas supply tube” of the present invention, but the present invention is not limited to the above description. For example, in a piping system for cathode gas as well, the above control method for shut-off valves can be applied. In this case, the air supply tube 71 shown in FIG. 1 is further provided with a shut-off valve on a downstream side of the compressor 21 functioning as the high-pressure gas source, a gas pressure regulating valve on a downstream side of this shut-off valve, and a shut-off valve on a downstream side of this gas pressure regulating valve.

1. A fuel cell system, in which a high-pressure gas supply tube is connected to a gas supply opening of a fuel cell, a gas pressure regulating valve is installed in the middle of the high-pressure gas supply tube, and upstream-side and downstream-side shut-off valves are provided respectively on the upstream side and the downstream side of the gas pressure regulating valve in the high-pressure gas supply tube, the fuel cell system comprising:
control means for delaying timing for opening the downstream-side shut-off valve by a predetermined time period with respect to timing for opening the upstream-side shut-off valve when the pressure difference between gas pressure on the upstream side of the upstream-side shut-off valve and gas pressure on the downstream side of the downstream-side shut-off valve is greater than a reference value.

2. The fuel cell system according to claim 1, wherein, when the pressure difference between gas pressure on the upstream side of the upstream-side shut-off valve and gas pressure on the downstream side of the downstream-side shut-off valve is greater than the reference value, and when the gas pressure on the downstream side of the downstream-side shut-off valve is smaller than an in-fuel-cell threshold value, which is determined with respect to residual gas pressure in the fuel cell, and also when the gas pressure between the upstream-side shut-off valve and the downstream-side shut-off valve is smaller than an in-tube threshold value, which is determined with respect to residual gas pressure in the high-pressure gas supply tube, the control means delays the timing for opening the downstream-side shut-off valve by a predetermined time period with respect to the timing for opening the upstream-side shut-off valve.

3. The fuel cell system according to claim 2, wherein the gas pressure between the upstream-side shut-off valve and the downstream-side shut-off valve is primary side pressure in the gas pressure regulating valve.

4. The fuel cell system according to claim 1, wherein the higher the gas pressure on the downstream side of the downstream-side shut-off valve is, the shorter the predetermined time period set by the control means is; and the higher the gas pressure between the upstream-side shut-off valve and the downstream-side shut-off valve is, the shorter the predetermined time period set by the control means is.

5. The fuel cell system according to claim 1, wherein the smaller the pressure difference between the gas pressure on the upstream side of the upstream-side shut-off valve and the gas pressure on the downstream side of the downstream-side shut-off valve is, the shorter the predetermined time period set by the control means is.

6. The fuel cell system according to claim 1, wherein the predetermined time period is a time period since the upstream-side shut-off valve is opened until the gas pressure between the upstream-side shut-off valve and the downstream-side shut-off valve becomes higher than the in-tube threshold value, which is determined with respect to the residual gas pressure in the high-pressure gas supply tube.

7. The fuel cell system according to claim 1, wherein the control means matches the timing for opening the upstream-side shut-off valve with the timing for opening the downstream-side shut-off valve when the pressure difference between the gas pressure on the upstream side of the upstream-side shut-off valve and the gas pressure on the downstream side of the downstream-side shut-off valve is smaller than the reference value.

8. The fuel cell system according to claim 1, further comprising a first pressure sensor which detects gas pressure on the upstream side of the upstream-side shut-off valve, and a second pressure sensor which detects gas pressure on the downstream side of the downstream-side shut-off valve, wherein the control means detects the pressure difference based on the first pressure sensor and the second pressure sensor.

9. The fuel cell system according to claim 1, wherein fuel gas flows in the high-pressure gas supply tube.

10. The fuel cell system according to claim 1, wherein a high-pressure gas source is connected to the upstream side of the upstream-side shut-off valve.

11. A control method for shut-off valves in a fuel cell system, in which a high-pressure gas supply tube is connected to a gas supply opening of a fuel cell, a gas pressure regulating valve is installed in the middle of the high-pressure gas supply tube, and upstream-side and downstream-side shut-off valves are provided respectively on the upstream side and the downstream side of the gas pressure regulating valve in the high-pressure gas supply tube, the control method comprising the step of:
delaying the timing for opening the downstream-side shut-off valve by a predetermined time period with respect to the timing for opening the upstream-side shut-off valve when the pressure difference between gas pressure on the upstream side of the upstream-side shut-off valve and gas pressure on the downstream side of the downstream-side shut-off valve is greater than a reference value.
